(19) United States
(12) Patent Application Publication
(10) Pub. No.: US 2009/0058189 A1
(43) Pub. Date: Mar. 5, 2009

(54) LONG RANGE LOW FREQUENCY RESONATOR AND MATERIALS

(75) Inventors: Nigel P. Cook, El Cajon, CA (US); Lukas Sieber, Olten (CH); Hanspeter Widmer, Wohlenschwill (CH)

Correspondence Address: Law Office of Scott C Harris Inc, PO Box 1389, Rancho Santa Fe, CA, 92067, US

(73) Assignee: NIGELPOWER, LLC, San Diego, CA (US)

(21) Appl. No.: 12/189,720

(22) Filed: Aug. 11, 2008

Related U.S. Application Data
(60) Provisional application No. 60/955,598, filed on Aug. 13, 2007.

(51) Int. Cl. H02J 17/00

(52) U.S. Cl. 307/104; 307/149

(57) ABSTRACT

Transmission of power at low frequencies, e.g. less than 1 MHz. The power can be transmitted in various ways, using different structures included stranded wire such as Litz wire. The inductor can also use cores of ferrites for example. Passive repeaters can also be used.

This application claims priority from provisional application No. 60/955,598, filed Aug. 13, 2007, the entire contents of which disclosure is herewith incorporated by reference.

### BACKGROUND

It is desirable to transfer electrical energy from a source to a destination without the use of wires to guide the electromagnetic fields. A difficulty of previous attempts has been low efficiency together with an inadequate amount of delivered power.

Our previous applications and provisional applications, including, but not limited to, U.S. patent application Ser. No. 12/018,069, filed Jan. 22, 2008, entitled “Wireless Apparatus and Methods”, the entire contents of the disclosure of which is herewith incorporated by reference, describe wireless transfer of power.

The system can use transmit and receiving antennas that are preferably resonant antennas, which are substantially resonant, e.g., within 10% of resonance, 15% of resonance, or 20% of resonance. The antenna(s) are preferably of a small size to allow it to fit into a mobile, handheld device where the available space for the antenna may be limited. An efficient power transfer may be carried out between two antennas by storing energy in the near field of the transmitting antenna, rather than sending the energy into free space in the form of a travelling electromagnetic wave. Antennas with high quality factors can be used. Two high-Q antennas are placed such that they react similarly to a loosely coupled transformer, with one antenna inducing power into the other. The antennas preferably have Qs that are greater than 1000.

### SUMMARY

The present application describes transfer of energy from a power source to a power destination via electromagnetic field coupling. Embodiments describe techniques for new coupling structures, e.g., transmitting and receiving antennas.

### BRIEF DESCRIPTION OF THE DRAWINGS

These and other aspects will now be described in detail with reference to the accompanying drawings, wherein:

FIG. 1 shows a block diagram of a magnetic wave based wireless power transmission system;

FIG. 2 illustrates circuit diagrams of the circuits in the FIG. 1 diagram;

FIG. 3 illustrates an exemplary near field condition plot

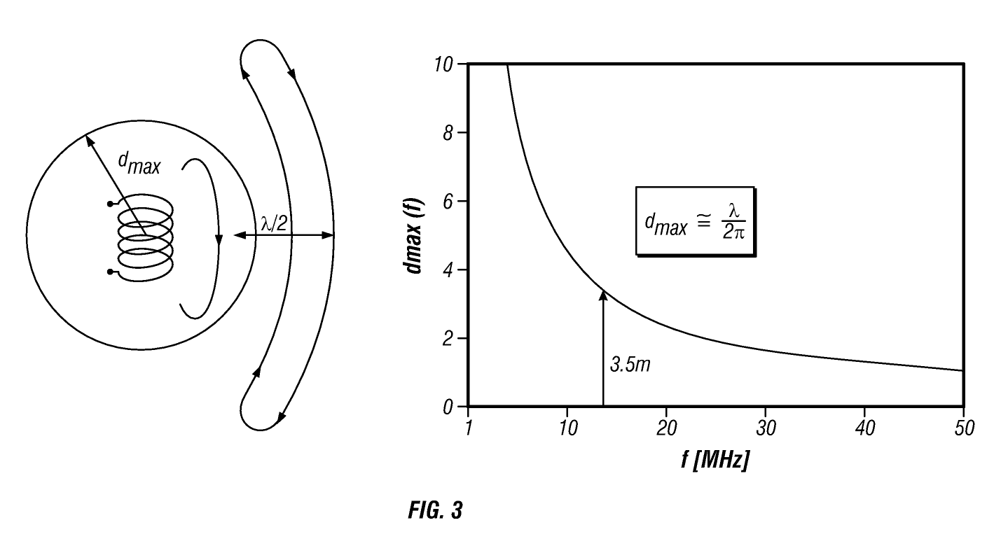

### DETAILED DESCRIPTION

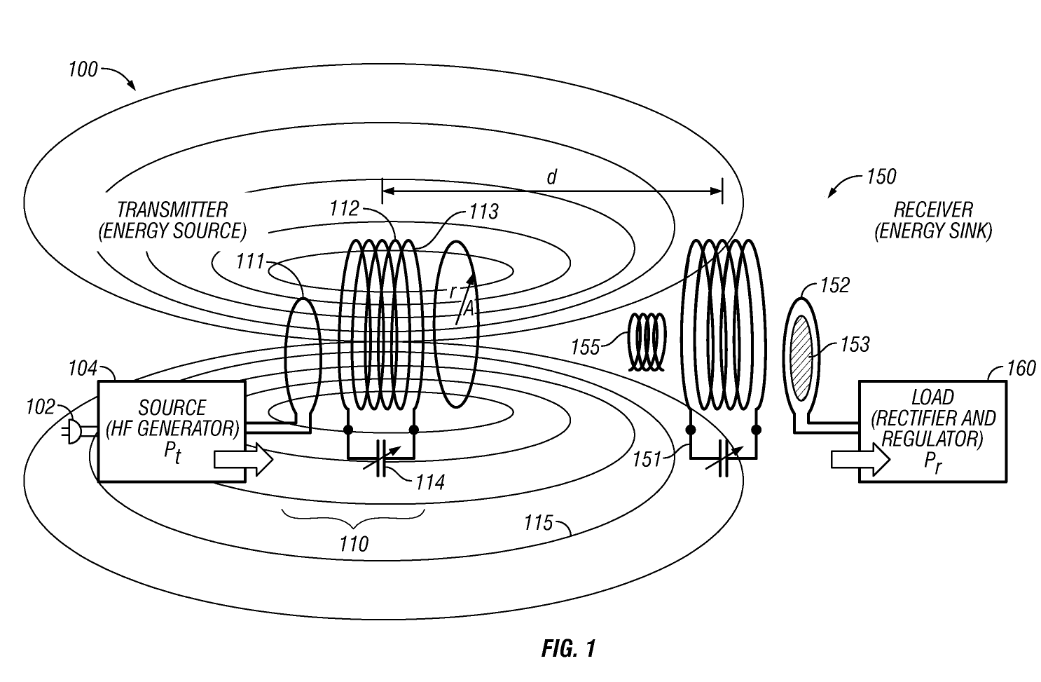

A basic embodiment is shown in FIG. 1. A power transmitter assembly 100 receives power from a source, for example, an AC plug 102. A frequency generator 104 is used to couple the energy to an antenna 110, here a resonant antenna. The antenna 110 includes an inductive loop 111, which is inductively coupled to a high Q resonant antenna part 112. The resonant antenna includes a number N of coil loops 113 each loop having a radius R_{A}. A capacitor 114, here shown as a variable capacitor, is in series with the coil 113, forming a resonant loop. In the embodiment, the capacitor is a totally separate structure from the coil, but in certain embodiments, the self capacitance of the wire forming the coil can form the capacitance 114.

The frequency generator 104 can be preferably tuned to the antenna 110, and also selected for FCC compliance.

This embodiment uses a multidirectional antenna. 115 shows the energy as output in all directions. The antenna 100 is non-radiative, in the sense that much of the output of the antenna is not electromagnetic radiating energy, but is rather a magnetic field which is more stationary. Of course, part of the output from the antenna will in fact radiate.

Another embodiment may use a radiative antenna.

A receiver 150 includes a receiving antenna 155 placed a distance D away from the transmitting antenna 110. The receiving antenna is similarly a high Q resonant coil antenna 151 having a coil part and capacitor, coupled to an inductive coupling loop 152. The output of the coupling loop 152 is rectified in a rectifier 160, and applied to a load. That load can be any type of load, for example a resistive load such as a light bulb, or an electronic device load such as an electrical appliance, a computer, a rechargeable battery, a music player or an automobile.

The energy can be transferred through either electrical field coupling or magnetic field coupling, although magnetic field coupling is predominantly described herein as an embodiment.

Electrical field coupling provides an inductively loaded electrical dipole that is an open capacitor or dielectric disk. Extraneous objects may provide a relatively strong influence on electric field coupling. Magnetic field coupling may be preferred, since extraneous objects in a magnetic field have the same magnetic properties as “empty” space.

The embodiment describes a magnetic field coupling using a capacitively loaded magnetic dipole. Such a dipole is formed of a wire loop forming at least one loop or turn of a coil, in series with a capacitor that electrically loads the antenna into a resonant state.

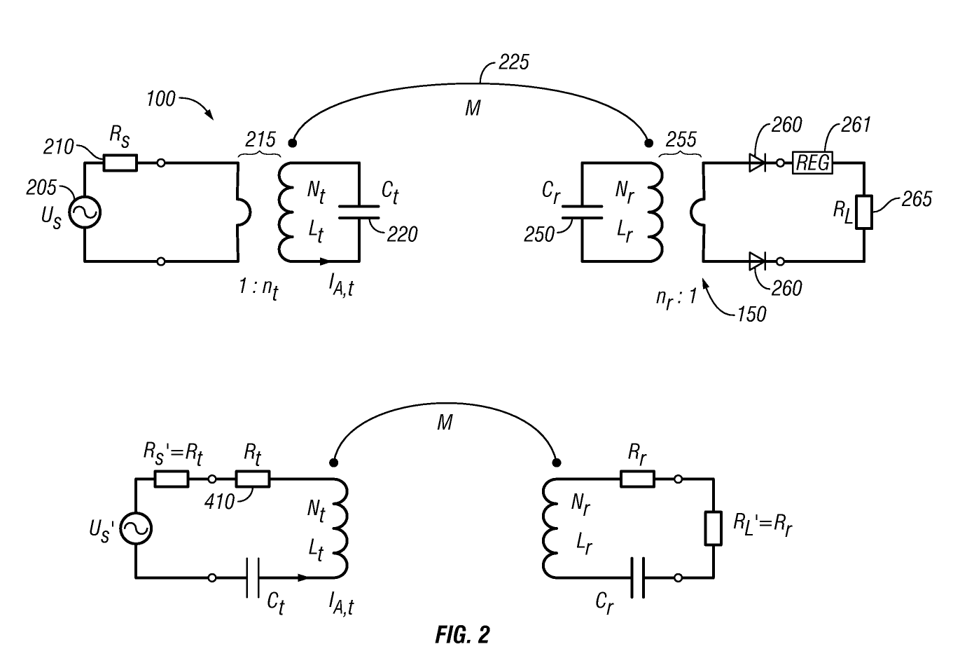

FIG. 2 shows an equivalent circuit for the energy transfer. The transmit circuit 100 is a series resonant circuit with RLC portions that resonate at the frequency of the high frequency generator 205. The transmitter includes a series resistance 210, and inductive coil 215, and the variable capacitance 220. This produces the magnetic field M which is shown as magnetic lines of force 225.

The signal generator 205 has an internal resistance that is preferably matched to the transmit resonator's resistance at resonance by the inductive loop. This allows transferring maximum power from the transmitter to the receiver antenna.

The receive portion 150 correspondingly includes a capacitor 250, transformer coil 255, rectifier 260, and regulator 261, to provide a regulated output voltage. The output is connected to a load resistance 265. FIG. 2 shows a half wave rectifier, but it should be understood that more complex rectifier circuits can be used. The impedance of the rectifier 260 and regulator 261 is matched to the resistance of the receive resonator at resonance. This enables transferring a maximum amount of power to the load. The resistances take into account skin effect/proximity effect, radiation resistance, as well as both internal and external dielectric loss.

A perfect resonant transmitter will ignore, or minimally react with, all other nearby resonant objects having a different resonant frequency. However, when a receiver that has the proper resonant frequency encounters the field of the transmitting antenna 225, the two couple in order to establish a strong energy link. In effect, the transmitter and receiver operate to become a loosely coupled transformer.

The inventors have discovered a number of factors that improve the transfer of power from transmitter to receiver.

Q factor of the circuits, described above, can assist with certain efficiencies. A high Q factor allows increased values of current at the resonant frequency. This enables maintaining the transmission over a relatively low wattage. In an embodiment, the transmitter Q may be 1400, while the receiver Q is around 300. For reasons set forth herein, in one embodiment, the receiver Q may be much lower than the transmitter Q, for example ¼ to ⅕ the transmitter Q. However, other Q factors may be used. The Q of a resonant device is the ratio of the resonant frequency to the so-called “3 dB” or “half power” bandwidth of the resonant device. While there are several “definitions,” all are substantially equivalent to each other, to describe Q in terms of measurements or the values of resonant circuit elements.

High Q has a corresponding disadvantage of narrow bandwidth effects. Such narrow bandwidths have typically been considered as undesirable for data communications. However, the narrow bandwidth can be used in power transfer. When a high Q is used, the transmitter signal is sufficiently pure and free of undesired frequency or phase modulation to allow transmission of most of its power over this narrow bandwidth.

For example, an embodiment may use a resonant frequency with a substantially un-modulated fundamental frequency. Some modulation on the fundamental frequency may be tolerated or tolerable, however, especially if other factors are used to increase the efficiency. Other embodiments use lower Q components, and may allow correspondingly more modulation on the fundamental.

An important feature may include use of a frequency which is permitted by regulation, such as FCC regulations. The preferred frequency in this exemplary embodiment is 13.56 MHz but other frequencies may be used as well.

In addition, the capacitors should be able to withstand high voltages, for example as high as 1000 V, since the resistance may be small in relation to the capacitive reactance. A final important feature is the packaging: the system should be in a small form factor.

One aspect of improving the coupling between the transmit and receive antenna is to increase the Q of the antenna. The efficiency of power transfer η may be expressed as

$$η ( d ) ≅ \frac{{r}_{A , i}^{3} \cdot {r}_{A , r}^{3} \cdot {Q}_{i} \cdot {Q}_{r}}{16 {d}^{6}} .$$

Note that this increases as the cube of the radius of the transmitting antenna, the cube of the radius of the receiving antenna, and decreases to the sixth power of the distance. The radii of the transmit and receive antennas may be constrained by the application in which they are used. Accordingly, increasing the Q in some applications may be the only practical way of increasing the efficiency.

In an embodiment, the frequency of the wave used for transmitting the power is in the “ISM band” e.g., at 135 kHz. Other “low” frequencies can be used, for example, 160 KHz, 457 Khz, or any frequency less than 1 Mhz is considered herein to be “low” frequency. This frequency band is referred to herein as low frequency, or “LF”. For example, personal identification units that use this Low Frequency (LF) band for the detection of avalanche victims—the Barryvox™ system.

This LF system uses frequencies with a longer wavelength. In essence, this system effectively sends power to a shorter range in regards to the slope of the field strength. Because of the properties of the LF system, the quality factor of the circuits and antennas may be somewhat lowered. The inventors prefer a Q of 1000 or higher.

Higher frequency systems of this type have used lower numbers of coil turns to increase Q. The LF system has a lower skin effect than other (HF) systems. The LF system has a higher number of turns. A first embodiment of the LF system may use Ferrites, e.g., non-conductive ferromagnetic ceramic compounds as cores within the coils. For example, any material XY₂O₄, where X and Y are each a different metal cation, can be used as the ferrites in an embodiment. One preferred material may be ZnFe₂O₄.

The ferrites can be used as “cores” for the antennas e.g., any or all of 111, 112, 151, 152. For example, antenna 152 is shown with a ferrite core 153 therein.

Another embodiment may use Litze wire as the coils, e.g., any or all of 111, 112, 151, 152 may be formed of Litze wire. This is a bundle of thin wires that are interwoven, but mutually isolated to force current to be distributed over the full cross section of the wire.

The receiver is the highest priority in order to get good performance. The receiver will have high relative power values, will need a few hundred nanofarads of capacitance, and a Q value that is “high”, e.g, greater than 100, more preferably greater than 300, or greater than 1000. In an embodiment, the receiver is of PDA size, e.g. (60 mm×100 mm).

The transmitter preferably uses vacuum capacitors to keep a high Q.

Another embodiment of the receiver uses air coils, optimized with capacitors as described herein.

An embodiment may use multiple transmitters and/or passive parasitic loops (pure resonators) placed behind picture frames or under tables to act as repeaters that are activated by the transmitter. One such repeater is shown as 155 in FIG. 1. The transmitter then acts as a mother antenna for the long range hop. The parasitic loops act as a short range hop. This configuration is in fact multiple transmitters, but requiring neither separate feeding nor mutual frequency synchronization parasitic antennas (energy relays).

One aspect of the embodiment is the use of a high efficiency that comes from increasing the Q factor of the coupling structures (primarily the antennas) at the self-resonant frequency used for the sinusoidal waveform of the electromagnetic field, voltage or current used. The efficiency and amount of power is superior for a system which uses a single, substantially un-modulated sine wave. In particular, the performance is superior to a wide-band system which attempts to capture the power contained in a wideband waveform or in a plurality of distinct sinusoidal waveforms of different frequencies. Other embodiments may use less pure waveforms, in recognition of the real-world characteristics of the materials that are used.

Although only a few embodiments have been disclosed in detail above, other embodiments are possible and the inventors intend these to be encompassed within this specification. The specification describes specific examples to accomplish˜more general goal that may be accomplished in another way. This disclosure is intended to be exemplary, and the claims are intended to cover any modification or alternative which might be predictable to a person having ordinary skill in the art. For example, other sizes, materials and connections can be used. Although the coupling part of the antenna is shown as a single loop of wire, it should be understood that this coupling part can have multiple wire loops. Other embodiments may use similar principles of the embodiments and are equally applicable to primarily electrostatic and/or electrodynamic field coupling as well. In general, an electric field can be used in place of the magnetic field, as the primary coupling mechanism.

Also, the inventors intend that only those claims which use the-words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A wireless power transmitter system, comprising:
a connection to a source of line power;
a modulating part, which modulates said line power to create a first frequency of lower than 1 MHz; and
a transmitter part, including a transmitting antenna formed of a conductive loop with a capacitor that brings said antenna to resonance at said first frequency, and which produces a magnetic field based on said source of line power, said transmitter part having a Q factor at said frequency, where said Q factor is at least 300.

2. A system as in claim 1, wherein said Q factor is at least 1000.

3. A system as in claim 1, wherein said antenna uses stranded wire for said conductive loop formed of multiple strands which each carry current but are each insulated from one another.

4. A system as in claim 1, wherein said antenna uses a core inside said inductive loop.

5. A system as in claim 4, wherein said core is formed of a ferrite material.

6. A system as in claim 5, wherein said conductive loop is formed of a stranded wire material formed of multiple strands which each carry current but are each insulated from one another.

7. A system as in claim 6, wherein said stranded wire material is Lutz wire.

8. A system as in claim 1, further comprising at least one passive loop, tuned to repeat a magnetic field produced by said transmitter.

9. A system as in claim 1, wherein said first frequency is lower than 500 kHz.

10. A system as in claim 1, further comprising a receiver that has an antenna formed of a coil loop and a capacitor which makes a resonant circuit at said first frequency that has magnetic energy induced therein by said transmitter, and which produces output power.

11. A system as in claim 10, wherein said antenna in said receiver uses stranded wire in said coil loop formed of multiple strands which each carry current but are each insulated from one another.

12. A system as in claim 10, wherein said antenna in said receiver uses ferrites as a core for said coil loop.

13. A wireless power receiver system, comprising:
a receiver part, including a receiving antenna formed of a conductive loop with a capacitor that brings said antenna to resonance at a first frequency, and which receives a magnetic field and produces an output that is based on the magnetic field, said first frequency being lower than 1 Mhz; and
a rectifier, which rectifies said output to produce a power output.

14. A system as in claim 13, wherein a Q factor of said receiver part is at least 300.

15. A system as in claim 13, wherein said antenna uses stranded wire for said conductive loop, formed of multiple strands which each carry current but are each insulated from one another.

16. A system as in claim 13, wherein said antenna uses a core inside said inductive loop.

17. A system as in claim 16, wherein said core is formed of a ferrite material.

18. A system as in claim 17, wherein said conductive loop is formed of a stranded wire material, formed of multiple strands which each carry current but are each insulated from one another.

19. A system as in claim 18, wherein said stranded wire material is Lutz wire.

20. A system as in claim 12, further comprising at least one passive loop, tuned to repeat a magnetic field at said first frequency.

21. A system as in claim 12, wherein said first frequency is lower than 500 kHz.

22. A system as in claim 12, further comprising a transmitter that has an antenna formed of a coil loop and a capacitor which makes a resonant circuit at said first frequency that has magnetic energy produced therein by a source of line power.

23. A system as in claim 22, wherein said antenna in said receiver uses stranded wire in said coil loop.

24. A system as in claim 22, wherein said antenna in said receiver uses ferrites as a core for said coil loop.

25. A method of transmitting power, comprising:
using electrical power to create a signal having a first frequency of lower than 1 MHz;
using an antenna which is self resonant at said first frequency to transmit said signal; and
using a passive repeater that is activated by the transmitter to repeat said signal at said first frequency.

26. A method as in claim 25, wherein said antenna includes an inductive loop, and a capacitor that brings the antenna to resonance at said first frequency.

27. A method as in claim 26, wherein said antenna is formed of stranded wire formed of multiple strands which each carry current but are each insulated from one another.

28. A method as in claim 26, wherein said inductive loop includes a core portion formed of ferrite.

29. A method as in claim 25, wherein said repeater is formed of stranded wire.

30. A method as in claim 25, wherein said repeater includes a core formed of ferrite.
